(19) United States
(12) Patent Application Publication
(10) Pub. No.: US 2015/0256600 A1
(43) Pub. Date: Sep. 10, 2015

(54) SYSTEMS AND METHODS FOR MEDIA FORMAT SUBSTITUTION

(71) Applicant: Citrix Systems, Inc., Fort Lauderdale, FL (US)

(72) Inventors: Kapil DAKHANE, Santa Clara, CA (US); Patrick Kevin HOGAN, Chicago, IL (US); Robert KIDD, Champaign, IL (US); Nicholas James STAVRAKOS, Los Altos, CA (US); Miguel Angel MELNYK, Champaign, IL (US)

(73) Assignee: Citrix Systems, Inc., Fort Lauderdale, FL (US)

(21) Appl. No.: 14/198,276

(22) Filed: Mar. 5, 2014

(51) Int. Cl. H04L 29/08; H04L 29/06

(52) U.S. Cl. CPC H04L 67/10; H04L 65/60; H04L 67/42

(57) ABSTRACT

Systems and methods are disclosed for media format substitution. In accordance with one implementation, a method is provided for media format substitution. The method includes receiving from a client device a request for media data having a first media format, determining whether the client device supports a second media format, and based on the determination, sending to the client device a content type identifier associated with the second media format. The method also includes obtaining the media data from a content server or a content cache, generating, based on the obtained media data, formatted media data corresponding to the second media format, and sending the formatted media data to the client device.

### BACKGROUND

One of the most popular types of content downloaded by users today is media content, such as video, image, and audio files. Media content comes in different formats, where some formats are more suitable for real-time media streaming than other formats. For example, HTTP Live Streaming (HLS) is a popular media streaming format because it breaks the overall stream into a sequence of small HTTP-based file downloads, each download loading one short segment of the overall stream. As the stream is played, the client device may select from a number of alternate short segments containing the same material encoded at a variety of data rates, allowing the streaming session to adapt to the available data rate. At the start of the streaming session, the client device downloads an extended M3U playlist (an .m3u8 file) containing the index data for the various segments available for this stream. Each segment can be stored as a separate .ts file compliant with the MPEG transport stream (TS) container format, and can include both video and audio streams, such as an H.264-encoded video stream and an advanced audio coding (AAC)-encoded audio stream.

On the other hand, some container formats are not well adapted for real-time streaming, especially for real-time streaming that may involve real-time adjustments of bitrate, frame resolution, and so forth. For example, the MPEG-4 Part 14 (MP4) format makes any such adjustments very difficult, because it requires that the index data (the “moov” atom) be transmitted in advance. Because the MP4 index data defines frame sizes for the entire stream, no frame can change in size after the index data is transmitted, which significantly constrains any real-time bitrate adjustments.

### BRIEF DESCRIPTION OF THE DRAWINGS

Reference will now be made to the accompanying drawings, which illustrate exemplary embodiments of the present disclosure. In the drawings:

FIG. 1 is a block diagram of an exemplary system, consistent with embodiments of the present disclosure;

FIG. 2 is a flowchart of an exemplary format substitution method, consistent with embodiments of the present disclosure;

FIG. 3 illustrates an exemplary playlist, consistent with embodiments of the present disclosure;

FIG. 4 is an exemplary time diagram, consistent with embodiments of the present disclosure; and

FIG. 5 is another exemplary time diagram, consistent with embodiments of the present disclosure.

### DESCRIPTION OF EXEMPLARY EMBODIMENTS

Reference will now be made in detail to the exemplary embodiments, examples of which are illustrated in the accompanying drawings. Wherever possible, the same reference numbers will be used throughout the drawings to refer to the same or like parts.

Exemplary embodiments disclosed herein are directed to methods and systems for media format substitution. Although container formats MP4 and TS (as part of HLS) and HTTP communications are used in the exemplary embodiments to illustrate format substitution, format substitution may be performed on any other media container formats and over any other Internet protocol. The format substitution technique can allow for intercepting one or more requests for media data, processing the requested media data, and generating formatted media data that can be more optimized for real-time streaming, e.g., for real-time bitrate adjustments based on the changing network conditions. In addition, the format substitution technique can enable features that were not available in the original format, but are available in the format that substitutes the original format. For example, some devices can support “pacing”—requesting the segments substantially at playback rate as opposed to requesting them as fast as the network allows it. Because users may not need the entire contents of the media, such aggressive downloading can be unnecessary, and avoiding it can free up bandwidth and processing resources of the client device and of network servers. However, some devices and applications may only support pacing with some formats (e.g., HLS) but not with other formats (e.g., MP4).

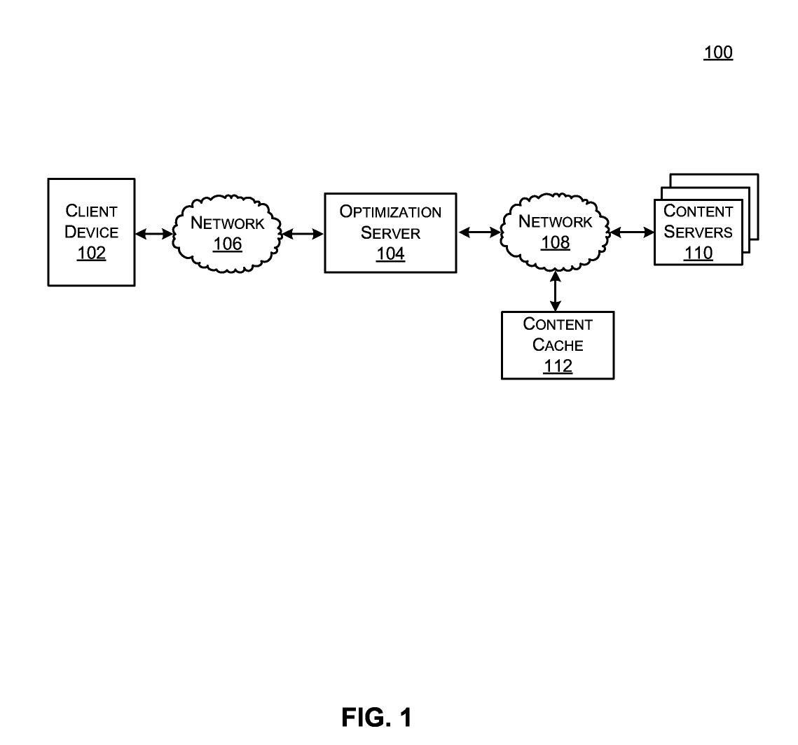

FIG. 1 illustrates a block diagram of an exemplary system 100. Exemplary system 100 may be any type of system that provides media data over a local connection or a network, such as a wireless network, Internet, broadcast network, etc. Exemplary system 100 may include, among other things, a client device 102, an optimization server 104, one or more networks 106 and 108, and one or more content servers 110.

Client device 102 can be implemented as an electronic device such as a computer, a PDA, a cell phone, a laptop, a desktop, or any other device that can access a data network. Client device 102 can include software applications that allow the device to communicate with and receive data packets, such as data packets of media data, from a data network. For example, client device 102 can send request data to a content server to download a particular media data file, and the content server can transmit the media data file to client device 102. In some embodiments, the request data, the media data file, or both, can be routed through optimization server 102. Client device 102 can provide a display and one or more software applications, such as a media player or an Internet browser, for displaying the received media data to a user of the client device.

Optimization server 104 can be implemented as a software program and/or one or more electronic devices such as a proxy server, a router, a firewall server, or a host, or any other electronic device that can intercept and facilitate communications between client device 102 and content servers 110. The optimization server can include one or more hardware processors, such as general purpose microprocessors or special-purpose digital signal processors. The optimization server can also include a memory, such as a random access memory (RAM) or other dynamic storage device, for storing information and instructions to be executed by the one or more processors. Such instructions, when stored in non-transitory storage media accessible to the one or more processors, can render the optimization server into a special-purpose machine that is customized to perform the operations specified in the instructions. The term “non-transitory media” as used herein refers to any media storing data and/or instructions that cause a machine to operate in a specific fashion. Such non-transitory media can comprise non-volatile media and/or volatile media. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The optimization server can also include one or more communication interfaces that can provide a two-way data communication coupling to networks 106 and 108 and through which the optimization server can communicate with client device 102, content servers 110, and content cache 112. For example, the communication interface can be an integrated services digital network (ISDN) card, cable modem, satellite modem, or a modem to provide a data communication connection to a corresponding type of telephone line. As another example, the communication interface can be a local area network (LAN) card to provide a data communication connection to a compatible LAN. Wireless links can also be implemented. In any such implementation, communication interface sends and receives electrical, electromagnetic or optical signals that carry digital data streams representing various types of information.

Optimization server 104 can perform real-time, on-the-fly modification to certain media formats. The modification process can include, for example, format container modification, transcoding, compressing, optimizing, dynamic bandwidth shaping (DBS), or any other real-time, on-the-fly modifications of media data.

In some embodiments, optimization server 104 can perform format substitution method 200, described in detail below. In addition, optimization server 104 can apply budget encoding techniques to an original MP4 file, such as the techniques described in U.S. Patent Publication No. 2011/0090953 entitled “Budget Encoding”, the entire content of which is hereby incorporated by reference. In budget encoding techniques, the original media file (e.g., MP4 file) may be coded to a lower bitrate without substantially changing the media format.

As an alternative to the configuration of system 100 shown in FIG. 1, the processing performed by optimization server 104 can be performed by any of the content servers 110, or any network device between client device 102 and content servers 110.

Content servers 110 can be one or more computer servers that store media content or access stored media content from one or more data storage devices associated with the corresponding content server. Content servers 110 can receive a request for media data from client device 102 (either directly or through optimization server 104), process the request, and provide the requested media content to client device 102, either directly or through optimization server 104. Content servers 110 can be, for example, web servers, enterprise servers, or they can be PDAs, cell phones, laptops, desktops, or any devices configured to transfer media data to client device 102 through one or more networks 106 and 108 and, in some embodiments, through optimization server 104. Further, content servers 110 can be broadcasting facilities, such as free-to-air, cable, satellite, and other broadcasting facilities configured to distribute media data to client device 102, in some embodiments, through optimization server 104.

Content cache 112 can be one or more electronic devices, such as computer servers, storage devices, etc., that store cached media content. Content cache 112 can receive a request for cached media data from optimization server 104, process the request, and if the cached media data is available, provide the requested cached media content to optimization server 104. Content cache 112 can be a part of optimization server 104, or it can be remotely accessible by optimization server 104.

Networks 106 and 108 can include any combination of wide area networks (WANs), local area networks (LANs), or wireless networks suitable for packet-type communications, such as Internet communications, or broadcast networks suitable for distributing media content.

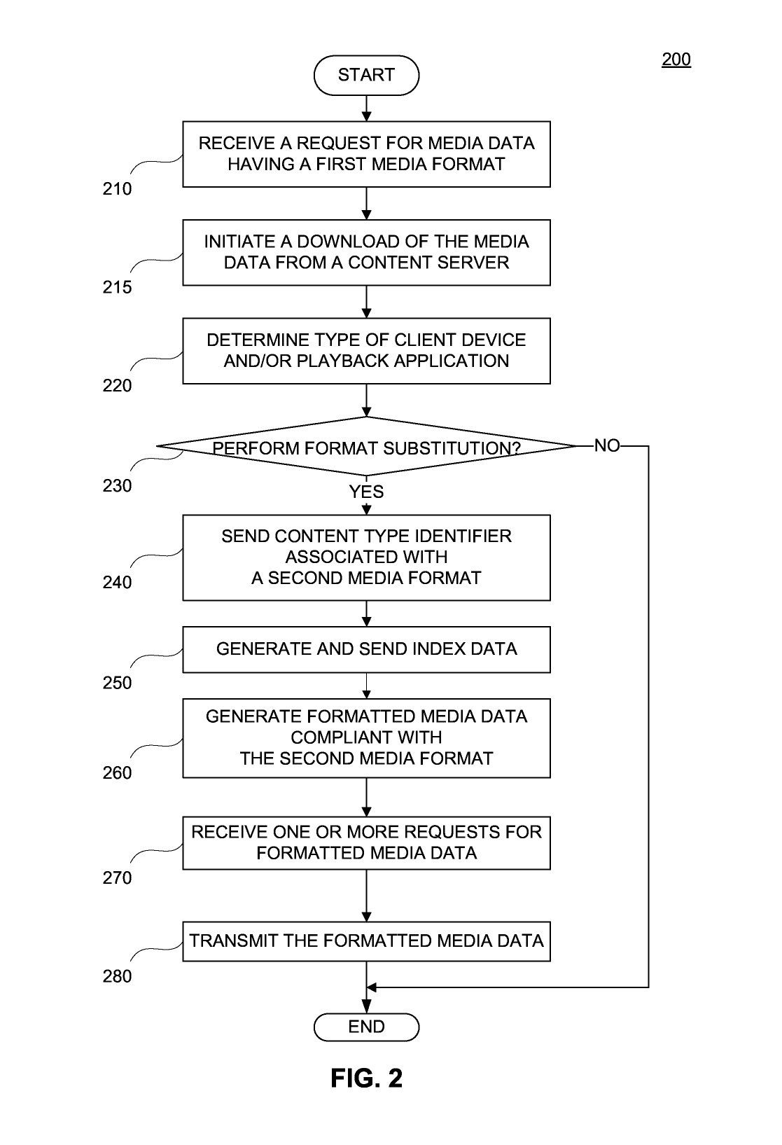

Referring now to FIG. 2, a flowchart representing an exemplary format substitution method 200 is presented. Method 200 can be performed by one or more electronic devices, such as an optimization server (e.g., optimization server 104). While the flowchart discloses the following steps in a particular order, it is appreciated that at least some of the steps can be moved, modified, or deleted where appropriate, consistent with the teachings of the present disclosure.

At step 210, the optimization server can receive from the client device a request for media data. The request can be received over any suitable protocol, including UDP and TCP/IP protocols such as HTTP, HTTPS, FTP, SSH, etc. For example, the request can be an HTTP GET request that identifies the requested media data by a URL. The media data can be any combination of video data, audio data, image data, text data, and other types of data.

At step 215, the optimization server can initiate a download of the requested media data from the content server identified in the URL of the request. The optimization server can use any suitable protocol for initiating and downloading the data, including UDP and TCP/IP protocols such as HTTP, HTTPS, FTP, SSH, etc. After initiating the download, the optimization server begins receiving the requested media data from the content server. The requested media data can be received from the content server in one or more separate responses, such as HTTP 200 “OK” or HTTP 206 “Partial Content” responses. The optimization server can store some or all of the received media data either locally or in a remote server communicatively coupled to the optimization server.

In some embodiments, the optimization server can cache media data downloaded from the content server on a content cache (e.g., content cache 112). For example, at step 215, the optimization server can first determine whether the requested media data is stored on the content cache, and whether the stored media data is “fresh.” To make this determination, the optimization can, for example, request information associated with the media data (e.g., file timestamp, file headers, a fingerprint of the contents of the media data, etc.) from the content server and from the content cache, and compare the information to determine whether the media data on the content server differs from the media data in the content cache. If all or parts of media data in the content cache is determined to be fresh (e.g., identical to that on the content server), the optimization server can obtain those parts of media data from the content cache instead of obtaining them from the content server. If, however, all or some parts of media data are not in the content cache or are not fresh, the optimization server can download those parts from the content server, and optionally update the content cache to store the missing parts by sending them to the content cache. In some embodiments, the optimization server can store in the content cache the original media content as downloaded from the content server. In other embodiments, instead or in addition to storing the original media content, the optimization server can store in the content cache formatted, transcoded, optimized, and otherwise processed media data, such as segments of formatted media data (e.g., .ts files) discussed in detail below.

While step 215 appears in FIG. 2 immediately after step 210, it is appreciated that the optimization server can initiate the download at any point after step 210, for example, after step 230 and before step 240, or after step 240 and before step 250.

At step 220, the optimization server can determine, based on the received request or based on other communications received from the client device, the type of the client device (e.g., its brand, model, and/or operating system; whether it is a mobile device; etc.), the type and version of the playback application (e.g., a web browser, a media player, a YouTube mobile application, etc.), or both. Based on this information, the optimization server can determine, for example, whether the client device and application support playback of a particular media format, such as the HTTP Live Streaming (HLS) format. Alternatively, the optimization server can determine whether the client device and application support the particular media format without first determining the particular type of device and playback application. In some embodiments, the optimization server determines the type of the device, the type of the application, and/or whether the device and application support a particular type of format based on the “User-agent” field of the HTTP GET request. For example, if the User-agent field of the HTTP GET request includes the string “AppleCoreMedia” or similar strings, the optimization server can determine that the client device is a device running an iOS operating system (hereinafter, “iOS device”), and therefore supports HLS. As another example, if the User-agent field of the HTTP GET request includes the string “stagefright” or similar strings, the optimization server can determine that the client device is a device running an Android operating system (hereinafter, “Android device”) running a Stagefright Media Player, and therefore supports HLS.

In some embodiments (not shown in FIG. 2), if the optimization server determines, at step 220, that the client device and application do not support playback of one or more particular formats (e.g., formats optimized for streaming, such as HLS), the optimization server can decide not to perform the subsequent steps and method 200 can end. Otherwise, the optimization server can proceed to step 230.

In some embodiments, step 220 can be omitted. In these embodiments, the optimization device may not check whether the client device and application are of particular types and whether they support playback of one or more particular formats, for example, if previously obtained information indicates that they do.

At step 230, the optimization server can determine whether to perform media format substitution. In some embodiments, this determination can be based on whether the media format of the requested media data (hereinafter, the “original media format”) is a predetermined media format that is to be substituted. The predetermined media formats can be, for example, a locally or remotely stored list of one or more media formats. In some embodiments, the list can include video formats that do not support pacing, DBS, and/or video formats that are not optimized for streaming, such as video formats requiring the transmission of a frame index for the entire video before any video frames can be transmitted.

In some embodiments, the optimization server determines the original media format based on the request received from the client device, for example, based on the URL of the resource included in the HTTP GET request. For example, if the HTTP GET request includes a URL “http://example.com/abc.mp4” or “http://example.com/path/abc?format=mp4,” the optimization server can determine that the original media format is MP4. Alternatively, or in addition, the optimization server can determine the original media format by obtaining at least a portion of the media data from the content server (or, if the download has already been initiated at step 215, waiting for at least a portion of the media data to be downloaded), and examining header information contained in that portion for an indication of the media data's format. By examining the header information, the optimization server can obtain not only the container format (e.g., MP4) but also the underlying codec type (e.g., H.264). After determining the original media format, the optimization server can determine whether it is one of the predetermined media formats.

In some embodiments, the determination, at step 230, whether to perform media format substitution can instead (or in addition) be based on the type of the client device and/or playback application, as determined at step 220. For example, the determination can be based on whether the client device is one of predetermined device types (e.g., an iOS device or an Android device). As another example, the determination can also be based on whether the playback application is an application that supports pacing, DBS, and/or supports at least one format optimized for streaming, such as HLS. As yet another example, the determination can also be based on whether the playback application is one of predetermined playback applications, such as a Safari browser, a YouTube application, a Stagefright Media Player, etc. In some embodiments, the optimization server can decide to perform format substitution if any one or more of the following conditions are true: a) the original media format is one of predetermined media formats; b) the type of the client device is one of predetermined device types; and c) the type of the requesting playback application is one of predetermined playback applications.

If the optimization server decides, at step 230, to perform format substitution, the method can proceed to step 240; otherwise, the method can end. In some embodiments, step 230 can be omitted, and the method can always proceed to step 240.

At step 240, the optimization server can send to the client device a content type identifier. In some embodiments, the content type identifier is transmitted as a part of a response that contains other information in addition to the content type identifier. For example, the content type identifier can be included in a header (e.g., the “content-type” header) of an HTTP 200 “OK” response or an HTTP 206 “Partial Content” response.

In some embodiments, the content type identifier can be associated with a second media format. The second media format can be selected by the optimization server from one of predetermined second media formats, and it can be different from the original media format. In some embodiments, the second media format can be a format that supports pacing, DBS, and/or is optimized for streaming, such as HLS. The content type identifier can identify the second media format, for example, by specifying one of Multipurpose Internet Mail Extension (MIME) types associated with the second media format. For example, the MIME types “application/x-mpegURL” and “application/vnd.apple.mpegURL” are each associated with the HLS media format.

Accordingly, in some embodiments, the optimization server sends, at step 240, an HTTP 200 or an HTTP 206 response having at least one of the following headers: “Content-Type: application/ x-mpegURL” or “Content-Type: application/vnd.apple.mpegURL.” When there are two or more MIME types associated with the second media format, like in the example provided above, the optimization server can select which MIME type to use based on the type of the client device and/or the type of the playback application. For example, the optimization server can send MIME type “application/x-mpegURL” for iOS client devices, and MIME type “application/vnd.apple.mpegURL” for Android devices.

By sending to the client device a content type identifier associated with a second media format, the optimization server provides an indication to the client device that the media data that will follow will have the second media format. Thus, the optimization server can indicate to the client device an upcoming transmission of media data having a second media format that is different from the original media format, that is, different from the media format of the media data requested by the client device. In some embodiments, this can cause the client device to disregard the original media format (e.g., MP4), and to handle the media data exactly as it would handle a media data having a second media format (e.g., HLS). Put differently, this can cause the client device to issue requests, process responses, handle playback, and present the media data to the user in a manner that is compliant with the second media format. This includes enabling features (e.g., pacing, DBS, and so forth) that were not inherently supported by the media format of the originally requested media data, but are supported by the second media format. In some embodiments, however, step 240 can be omitted, and the above-described format substitution effect can be achieved through other means. For example, the client device can recognize the second media format based on the index data sent at step 250 (described below), for instance, by determining that the index data corresponds to the second media format, and not the original media format.

At step 250, the optimization server can generate and send to the client device index data. Index data can include any type of preliminary data describing the media data, such as the length of the media (in bytes and/or in seconds), and if the media data is divided into several segments (chunks), the location (e.g., URL), and the duration of each segment. The optimization server can determine whether to send the index data, what information to include in the index data, and how to format it, based on the requirements of the second media format.

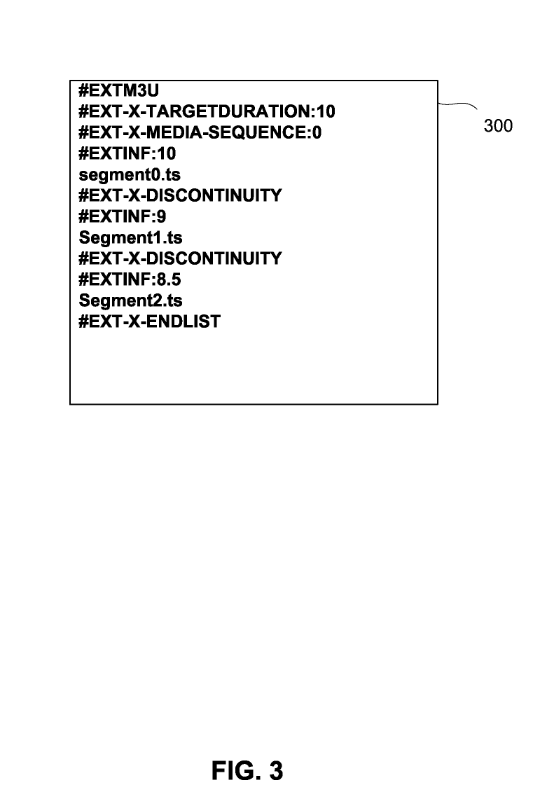

For example, if the selected second media format is HLS, the index data can include an .M3U or an .M3U8 file or contents thereof, hereinafter referred to as the “M3U playlist.” FIG. 3 illustrates an exemplary M3U playlist 300. As illustrated in FIG. 3, the M3U playlist can include, among other things, an opening tag #EXTM3U and a closing tag #EXT-X-ENDLIST, tag #EXT-X-TARGETDURATION indicating the maximum duration of any one segment, tag #EXT-X-MEDIA-SEQUENCE indicating the sequence number of the first segment, and one or more #EXTINF tags describing each segment. Each segment can be described by its duration (e.g., in seconds), and its URL. Each segment can have a unique URL that can be either absolute or relative to the path of the URL of the M3U playlist. In some embodiments, the URL can include a number corresponding to the segment's sequence number (position within the index data). FIG. 3 illustrates an example in which the M3U playlist includes three segments: a first segment located at a relative URL “segment0.ts” and having a duration of 10 seconds; a second segment located at a relative URL “segment1.ts” and having a duration of 9 seconds; and a third segment located at a relative URL “segment2.ts” and having a duration of 8.5 seconds.

The M3U playlist can contain additional tags, such as discontinuity tags #EXT-X-DISCONTINUITY between any two segments, indicating that there could be encoding discontinuity (e.g., a significant change in bitrate) between those two segments. In the example of FIG. 3, the M3U playlist contains descriptions of all the segments of the media data requested by the client device, such that no additional M3U playlists need to be downloaded to obtain description of additional segments. In some embodiments, not shown in FIG. 3, the M3U playlist can contain links to additional M3U playlists describing additional segments or further describing additional M3U playlists, in a hierarchical manner.

Still referring to step 250, the optimization server can generate the index data (e.g., the M3U playlist) based on the requested media data. The optimization server can decide to break the media data into one or more segments of a predetermined duration or of varying durations, and include in the index data a description of each segment. In some embodiments, the optimization server can generate and send the index data after it obtains the duration of the requested media data, but before all or any of the media data has been downloaded to the optimization server from the content server. In other embodiments, the optimization server can wait for the entire media data to be downloaded before it generates and sends the index data to the client device.

In some embodiments, the optimization server can send the index data to the client device together with the content type identifier. For example, the optimization server can send the generated M3U playlist (e.g., M3U playlist 300) in the same HTTP 200 or 206 response with the content type identifier. In other embodiments, the HTTP 200 or 206 response can contain a URL referring to the location of the M3U playlist (which can be stored by the optimization server either locally or on another server), in which case the M3U playlist can be subsequently requested by and provided to the client device.

In some embodiments, prior to sending to the client device the content type identifier (at step 240) and the index data (at step 250), the optimization server can send to the client device a redirect response (not shown). The redirect response can be one of HTTP 3xx responses (e.g., HTTP 302), and can provide notification to the client device that the requested media data has moved from its original location to a new location, specified in the redirect response. The optimization server can set the new location to an M3U8 file, which can be stored on the optimization server, in the content cache, or on another server accessibly by the optimization server. The redirect response can cause the client device to issue a new request for media data, specifying the new location. For example, if the original request was for “http://example.com/abc.mp4,” the optimization server can send a redirect response with the new location specified as “http://webs/hls/temp.m3u8.” The substituted extension (.m3u8 instead of the original .mp4) can provide to the client device another indication of format substitution, causing the client device to treat the upcoming media data as HLS stream, instead of the originally requested MP4 stream. After receiving the redirect response, the client device can issue a new request, this time requesting the URL ““http://webs/hls/temp.m3u8.” After receiving the new request, the optimization server can send to the client device the content type identifier and the index data, as described above in connection with steps 240 and 250.

At step 260, the optimization server can generate, based on the media data downloaded from the content server, formatted media data that is compliant with the second media format. For example, the optimization server can reformat the media data obtained from the content server to make it compliant with the second media format. Depending on the requirements of the second media format and the original format of the requested media data, the reformatting can include changing the container layer of the media data, changing the codec (decoding/decompressing and re-encoding/recompressing the media data using a different codec, also known as “transcoding”), or both. For example, the originally requested media data can be an MP4 file having an MP4-compliant container that contains H.264-coded video data AAC-coded audio data, and the second media format can be HLS, which supports both H.264-coded video data and AAC-coded audio data, but which does not support MP4 containers, and instead supports TS containers. In this example, the optimization server can create a .ts file having a TS container that contains the exact same H.264 video data and AAC audio data, unchanged. In cases like this where the media data includes several types of media streams (e.g., video, audio, text, etc.) encoded with different codecs, the second format can support some but not all of the codecs. In these cases, the optimization server can transcode only streams encoded with codecs unsupported by the second format, and not transcode streams that are encoded with codecs supported by the second format.

In some embodiments, the optimization server can decode, process, and re-encode the media data using new parameters, in order to optimize the stream in terms of bandwidth or in other aspects. For example, in the case of MP4→HLS reformatting, the optimization server can decode the H.264 stream, and re-encode it using H.264 or another codec, using a higher compression ratio (e.g., using greater quantization parameters) to achieve a lower bitrate. The optimization server can monitor the available network bandwidth between the client device and the optimization server, and adjust the bitrate of the formatted media data accordingly, as described, for example, in in U.S. Patent Publication No. 2011/0090953 entitled “Budget Encoding,” U.S. Pat, No. 7,991,904 entitled “Adaptive Bitrate Management for Streaming Media over Packet Networks,” and U.S. Patent Publication No. 2012/0314761 entitled “Adaptive Bitrate Management on Progressive Download with Indexed Media Files,” the entire contents of which are incorporated herein by reference.

The optimization server can perform the decoding/decompressing, re-encoding/recompressing, reformatting, optimizing, and other types of processing that generates formatted media data based on the media data, by utilizing any combination of software and hardware modules. For example, the optimization server can comprise one or more processors, as well as special-purpose digital signal processors (e.g., video and audio demultiplexers, decoders, multiplexers, encoders, etc.) configured to perform computationally intensive tasks, such as real-time decoding/decompressing and re-encoding/recompressing of media data. The processors can be configured to obtain the media data (e.g., from a first memory buffer), evaluate, process, and modify the media data, and store the modified media data (e.g., to a second memory buffer).

In some embodiments, the optimization server can wait for the media data to be fully downloaded from the content server before starting generating the formatted media data. In other embodiments, the optimization server can generate a segment of formatted media data as soon as a sufficient amount (e.g., in seconds) of media data has been downloaded from the content server, and keep generating new segments of formatted media data as soon as the next sufficient portions of media data get downloaded from the content server. After generating a segment of formatted media data, the optimization server can store that segment.

In some embodiments, the optimization server generates segments of formatted data such that they correspond to the segment descriptions of the index data (e.g., M3U playlist) generated and sent to the client device at step 250. For example, if at step 250 segment number N was described in the index data to have a length of T seconds and to be stored at location L, at step 260, the optimization server can generate its N-th formatted segment to have a length of T seconds, and will store it at location L. For example, if all segments were described in the index data as having a length of 10 seconds, the optimization server can wait for the first 10 seconds worth of media data to be downloaded from the content server and then start generating the first segment of formatted data. It can then wait for the next ten seconds worth of media data to be downloaded to start generating the second segment of formatted data, and so forth, until the entire media data has been downloaded and stored in one or more segments of formatted data. In some embodiments, the optimization server can decide not to split the formatted data into multiple segments, and instead generate and store one segment having the entire formatted media data.

Each segment of formatted data can be stored on the optimization server itself, in the content cache, or on any other server which can be accessed by the optimization server and by the client device. In some embodiments, wherever the segment is stored, its location is properly identified in the index data generated and sent to the client device at step 250. In other embodiments, the location of the segment may not correspond to the actual location at which that segment is stored. For example, to prevent any firewall-related issues, the optimization server can specify that a segment is located at the content server of the originally requested media data (e.g., http://example.com/abc_t0.ts), but in fact store the segment at a different location, for example, somewhere on the optimization server itself, in the content cache, or on another server accessible by the optimization server. In these embodiments, the optimization server is able to identify the real location at which the segment is stored, either by maintaining a look-up table translating the index-data locations to real storage locations, or by maintaining a unique session identifier, as described in more detail below, or by any other suitable means.

While FIG. 2 describes step 260 as being performed after step 250, it is appreciated that the steps can be performed in reverse order (i.e., the optimization server can generate formatted data before generating and sending the index data) or in parallel (i.e., the optimization server can generate several segments of formatted data, then generate and send index data to the client device, and then generate the remaining segments of formatted data). Moreover, as discussed above, in some embodiments the content cache can store previously generated formatted media data, or at least some segments thereof, in which case step 260 can be skipped for those segments. Accordingly, in those embodiments, if a particular segment of formatted cache was not previously generated and stored in the content cache, or if it was stored in the content cache but is no longer fresh, the optimization server can generate the segment of the formatted data at step 260, and then update the cache to store the newly generated segment.

At step 270, the optimization server can receive from the client device one or more requests for reformatted media data. In some embodiments, each request can correspond to one segment of reformatted media data as indicated in the index media. For example, the client device can first request the first segment of reformatted media (e.g., one that corresponds to the first segment in time), then the next segment (if there are more than one), and so on, until all segments of the reformatted media data are requested by the client device. In some embodiments, the requests can be HTTP GET requests, and can include, among other things, a URL specifying the location of the requested segment of reformatted data. In some embodiments, the URL is identical to the URL indicated in the description of the segment in the index data generated and sent at step 250. In other embodiments, the two URLs may not be identical (e.g., one can be an absolute path and the other can be a relative path), but point to the same location. In some embodiments, the optimization server can determine whether the URL refers to one of the segments that were listed in the index data, and if not, the optimization server can either completely discard the request, or resend to the client device the same index data that was sent at step 250.

In some embodiments, the client device can request the next segment of reformatted media data as soon as the previous segment has been successfully transmitted to it by the optimization server at step 280, discussed in detail below. Thus, the rate of incoming requests for segments can be related to the transmission rate. In other embodiments, when for example the playback application and the second media format support pacing, the client device can request a particular segment of reformatted media data only when this segment is about to be played back on the client device (e.g., within a predetermined number of seconds from being played). Thus, the rate of incoming requests for segments can be related to the playback rate, which is lower than the transmission rate if the reformatted media data is being played smoothly on the client device.

In some embodiments the client device can support several playback modes. For example, it can support a normal playback mode, where it requests and plays the segments sequentially. In addition, it can support playback at faster and/or slower speeds (e.g., 0.5×, 2×, 4×) and/or seek commands. To enable very fast playback or seek commands, the client device can request segments nonsequentially and out of order. For example, when the user wants to jump to a particular time within the media data, the client device can determine, based on the segment descriptions within the index data, which segment corresponds to (includes) that particular time, and request that segment out of order. For example, if the index data is M3U playlist 300 described in FIG. 3 and the user issues a seek command to time 00:20, the client device can determine, based on the order and duration of each segment in the playlist, that the requested time is included in the third segment (Segment2.ts) and requests that segment from the optimization server.

While FIG. 2 describes step 270 as being performed after step 260, it will be appreciated it can be performed before step 260, or in parallel with step 260. For example, the optimization server can begin receiving one or more requests for reformatted data from the client device at any point in time after it generates and sends index data at step 250. Accordingly, the optimization server may not have all or any segments of formatted media data generated when it receives the first request for reformatted data. In some embodiments, the optimization server can generate a predetermined amount (e.g., in seconds) of formatted media data at step 260 before it generates and sends index data to the client device, in order to guarantee that when the client device requests the first segment of the formatted data, that segment will be ready (i.e., generated and stored). Similarly, the optimization server can monitor the received requests and generate segments of formatted media data some time (e.g., a predetermined time) before those segments are requested. In some embodiments, however, the optimization server can receive a request for a segment that has not yet been generated and prepared. The optimization server can then generate and store the requested segment after receiving the request, and any delay caused by the generation and storing may not cause a delay in playback of the media data on the client device, because, as discussed above, the client device may accommodate for such delays by requesting segments in advance of their playback times.

At step 280, the optimization server transmits, in response to each request received at step 270, the requested formatted media data. For example, if the optimization server received, at step 270, a request for a particular .ts file (e.g., the file containing one segment of formatted media data generated and stored at step 260, and described in the index data generated and transmitted at step 250), at step 280 the optimization server will retrieve the file from the specified location and send the file to the client device. In some embodiments, the optimization server can send the file in an HTTP 200 response. As a part of the HTTP 200 response, the optimization server can specify the type of the transmitted content. For example, if HLS was selected as the second media format, and the requested segment of formatted data is a TS, the optimization server can include in the HTTP 200 response the following header: “Content-Type:video/MP2TS.”

Because the optimization server can process requests from numerous client devices, and because each client device can sometimes request more than one media data simultaneously, in some embodiments, the optimization server may need to associate each request with a particular session, e.g., with a particular media data requested by a particular client device. In some embodiments, the communication protocol used for sending the requests may not support sessions (e.g., a UDP-based protocol), or it may support sessions (e.g., a TCP/IP-based protocol such as HTTP) but assign a new session for each subsequent request. Accordingly, in these embodiments, the optimization server can implement its own session control, for example, by assigning a unique session ID to each original request for media data, and storing, in association with that session ID, the URL path of all the segments of formatted media data generated for that request. The optimization server can then retrieve the session ID based on the URL path of the requested formatted segment.

Instead of or in addition to the URL-based session identification, the optimization server can identify a particular session based on the session ID assigned by the client device and included in the segment requests. For example, the client device can assign a unique session ID to each requested media data, and include it in each request for segments of that media data, for example, in the “X-Playback-Session-Id” header of an HTTP GET request.

In some embodiments, the optimization server can compress some or all of its responses to the client device. For example, any of the HTTP responses (e.g., HTTP 200, 206, 302, etc.) can be compressed using, for example, using “gzip,” “deflate,” or any other suitable compression technique.

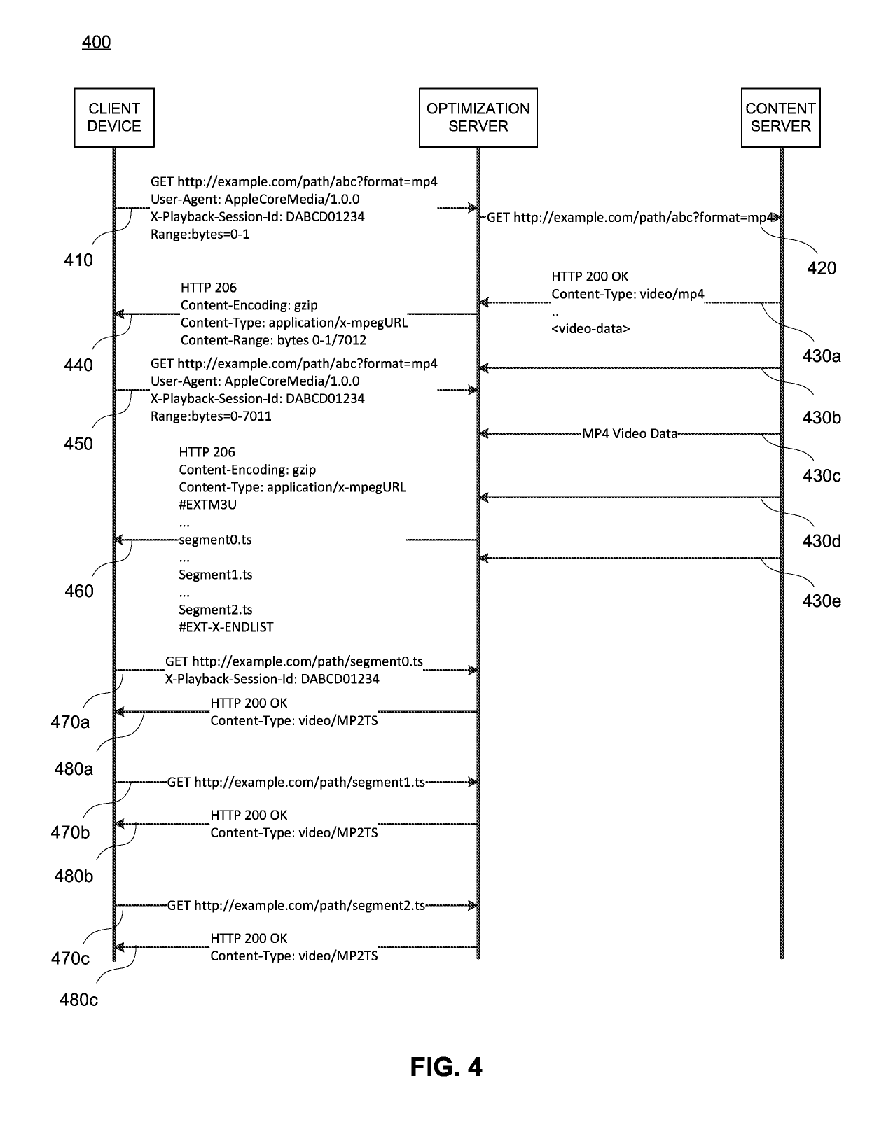

FIG. 4 shows a time diagram 400 illustrating exemplary data exchanges between the client device, the optimization server, and the content server, in accordance with some embodiments. In this example, the client device sends an HTTP GET request (410), requesting an MP4 media data located at URL “http://example.com/path/abc?format=mp4.” The client device can send the HTTP GET request (410) directly to the optimization server, or the request can be sent to the content server and intercepted by the optimization server. In the HTTP GET request, the client device also indicates that it is an iOS device, by including a header “User-Agent: AppleCoreMedia/1.0.0,” and includes a unique session ID “DABCD01234” identifying this new media data session. At first, the client device only requests the first two bytes of the media data, as indicated by the header “Range: bytes=0-1.” While the figure shows client device sending the request to the optimization server, it is appreciated that the optimization server can intercept the request that is intended for the content server.

After receiving the request, the optimization server initiates a download of the media data from the content server by sending to the content server identified in the client device's request (“example.com”) an HTTP GET request (420). In response, the content server sends to the optimization server the requested MP4 media data (430a-430e). Alternatively, as discussed above, the optimization server can determine that all or parts of the requested MP4 media data are stored and fresh in the content cache, and obtain those parts from the content cache.

At some point either before or after receiving any of the MP4 media data, the optimization server determines the type of the client device and/or playback application (e.g., in accordance with step 220 of method 200) and decides (e.g., in accordance with step 230 of method 200) to perform format substitution, choosing the second media format as HLS. Accordingly, at some point either before or after receiving any of the MP4 media data, the optimization server sends to the client device an HTTP 206 response (440) that includes the header “Content-Type: application/x-mpegURL,” which indicates to the client device that the media data it is about to receive is HLS data. In addition, the HTTP 206 response (440) can include the header “Content-Range: bytes 0-1/7012,” indicating that the first two bytes (as requested) out of the total of 7012 bytes of the requested file, are being transmitted.

After receiving the HTTP 206 response, the client device sends to the optimization server another HTTP GET request (450) for the same data, having the same session ID, but this time requesting the entire data, e.g., 7012 bytes, as indicated in the HTTP 206 response (440).

The optimization server then sends to the client device another HTTP 206 response (460), this time including in response index data (e.g., M3U playlist 300) describing, among other things, the durations and the locations of some or all segments of the reformatted data, or locations of other M3U playlists describing some or all of the segments. After receiving the index data, the client device issues a series of HTTP GET requests (470a, 470b, and 470c) requesting each of the segments described in the index data. After receiving each request, the optimization server optionally identifies the session ID corresponding to the request (e.g., based on the X-Playback-Session-Id and/or the segment URL, as discussed above), and sends to the client device the corresponding segment of reformatted data (480a, 480b, and 480c). As discussed above, the corresponding segment could have been generated by the optimization server based on the MP4 data received from the content server, and stored on the optimization server, or another server, but not necessarily on the original content server that stored the MP4 data, even though the index data and the subsequent requests for segments may indicate so. As further discussed above, in addition to reformatting media data into one or more TS segments, the optimization server can optionally decode and then re-encode the media data using the same or different codec, and using the same or different bitrates, where the bitrate can be different for each segment.

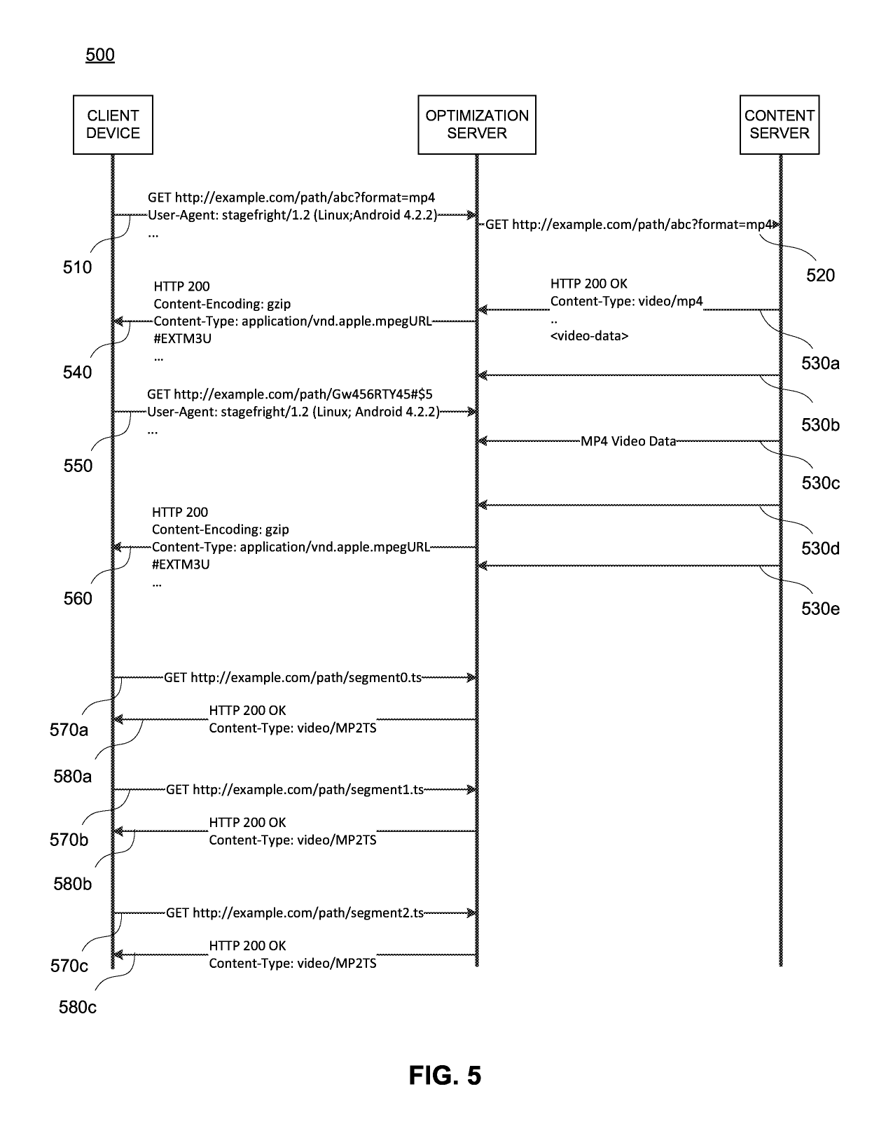

FIG. 5 shows another time diagram 500 illustrating exemplary data exchanges between the client device, the optimization server, and the content server, in accordance with some embodiments. As in the example of FIG. 4, here the client device sends an HTTP GET request (510), requesting an MP4 media data located at URL “http://example.com/path/abc?format=mp4.” The client can send the HTTP GET request (510) directly to the optimization server, or the request can be sent to the content server and intercepted by the optimization server. In the HTTP GET request, the client device also indicates that it is an Android device running a Stagefright Media Player, by including a header “User-Agent:stagefright/1.2 (Linux;Android 4.2.2). After receiving the request, the optimization server initiates a download of the media data from the content server by sending to the content server identified in the client device's request (“example.com”) an HTTP GET request (520). In response, the content server sends to the optimization server the requested MP4 media data (530a-530e).

At some point either before or after receiving any of the MP4 media data, the optimization server determines the type of the client device and/or playback application (e.g., in accordance with step 220 of method 200) and decides (e.g., in accordance with step 230 of method 200) to perform format substitution, choosing the second media format as HLS. Accordingly, at some point either before or after receiving any of the MP4 media data, the optimization server sends to the client device an HTTP 200 response (540) that includes the header “Content-Type: application/x-mpegURL,” which indicates to the client device that the media data it is about to receive is HLS data. In this example, the optimization server also includes in that response index data (e.g., M3U playlist 300) describing the durations and locations of some or all segments of the reformatted data, or locations of other M3U playlists describing some or all of the segments. After receiving the response, the client device issues an HTTP GET request (550) requesting a URL not recognized by the optimization server. This can be caused, for example, by the client device initially acting unpredictably due to the format substitution, which could be unexpected by the client device. Upon receiving the HTTP GET request (550), the optimization server can determine that the request does not correspond to any of the segments specified in the index data generated and sent earlier, and therefore can discard the request, and can issue another HTTP 200 response (560) similar or identical to the previous HTTP 200 response (540).

Next, the client device issues a series of HTTP GET requests (570a, 570b, and 570c) requesting each of the segments described in the index data. After receiving each request, the optimization server optionally identifies the session ID corresponding to the request (e.g., based on the segment URL, as discussed above), and sends to the client device the corresponding segment of reformatted data (580a, 580b, and 580c).

The methods disclosed herein may be implemented as a computer program product, i.e., a computer program tangibly embodied in an information carrier, e.g., in a machine readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

A portion or all of the methods disclosed herein may also be implemented by an application specific integrated circuit (ASIC), a field-programmable gate array (FPGA), a complex programmable logic device (CPLD), a printed circuit board (PCB), a digital signal processor (DSP), a combination of programmable logic components and programmable interconnects, a single central processing unit (CPU) chip, a CPU chip combined on a motherboard, a general purpose computer, or any other combination of devices or modules capable of performing media format substitution disclosed herein.

In the preceding specification, the systems and methods have been described with reference to specific exemplary embodiments. It will, however, be evident that various modifications and changes may be made without departing from the broader spirit and scope of the disclosed embodiments as set forth in the claims that follow. The specification and drawings are accordingly to be regarded as illustrative rather than restrictive. Other embodiments may be apparent to those skilled in the art from consideration of the specification and practice of the embodiments disclosed herein.

1. An electronic device comprising:
one or more interfaces configured to receive from a client device a request for media data having a first media format;
one or more processors configured to:
determine whether the client device supports a second media format, wherein based on the determination, the one or more interfaces are configured to send to the client device a content type identifier associated with the second media format;
obtain the media data from a content server or a content cache; and
generate, based on the obtained media data, formatted media data corresponding to the second media format,
wherein the one or more interfaces are configured to send the formatted media data to the client device.

2. The electronic device of claim 1, wherein the one or more processors are further configured to modify the media data's container format to comply with the second media format, without decoding or encoding the media data.

3. The electronic device of claim 1, wherein the one or more processors are further configured to decode the media data, process the decoded media data, and re-encode the processed media data with new parameters.

4. The electronic device of claim 1, wherein the formatted media data comprises one or more media data segments, wherein sending of the formatted media data comprises sending the media data segments, and wherein the one or more interfaces is further configured to:
send to the client device index data describing locations and durations of the media data segments; and
receive, from the client device, one or more additional requests for the media data segments.

5. The electronic device of claim 4, wherein the first media format is MP4, the second media format is supported by HTTP Live Streaming (HLS), and the index data has an M3U format, and wherein the electronic device is further configured to store in a memory each of the media data segments in a separate file having an MPEG-2 Transport Stream (TS) format.

6. The electronic device of claim 1, further comprising determining whether a fresh version of the media data is stored in the content cache and, based on the determination, obtaining the fresh version of the media data from the content cache.

7. The electronic device of claim 1, wherein the sending of the content type identifier is further based on a determination whether the first media format is one of predetermined media formats.

8. The electronic device of claim 1, wherein the one or more processors are further configured to determine an operating system type of the client device.

9. A method comprising:
receiving from a client device a request for media data having a first media format;
determining whether the client device supports a second media format;
based on the determination, sending to the client device a content type identifier associated with the second media format;
obtaining the media data from a content server or a content cache;
generating, based on the obtained media data, formatted media data corresponding to the second media format; and
sending the formatted media data to the client device.

10. The method of claim 9, wherein generating the formatted media data comprises modifying the media data's container format to comply with the second media format, without decoding or encoding the media data.

11. The method of claim 9, wherein generating the formatted media data comprises decoding the media data, processing the decoded media data, and re-encoding the processed media data with new parameters.

12. The method of claim 9, wherein the formatted media data comprises one or more media data segments, and wherein sending the formatted media data comprises sending the media data segments, the method further comprising:
sending to the client device index data describing locations and durations of the media data segments; and
receiving, from the client device, one or more additional requests for the media data segments.

13. The method of claim 12, wherein the first media format is MP4, the second media format is supported by HTTP Live Streaming (HLS), and the index data has an M3U format, the method further comprising storing each of the media data segments in a separate file having an MPEG-2 Transport Stream (TS) format.

14. The method of claim 9, further comprising determining whether a fresh version of the media data is stored on the content cache and, based on the determination, obtaining the fresh version of the media data from the content cache.

15. The method of claim 9, wherein sending to the client device a content type identifier is further based on a determination whether the first media format is one of predetermined media formats.

16. The method of claim 9, further comprising determining an operating system type of the client device.

17. A non-transitory computer-readable medium storing a set of instructions that are executable by one or more processors of an electronic device to cause the electronic device to perform a method comprising:
receiving a request for media data having a first media format, wherein the request is from a client device;
determining whether the client device supports a second media format;
based on the determination, sending to the client device a content type identifier associated with the second media format;
obtaining the media data from a content server or a content cache;
generating, based on the obtained media data, formatted media data corresponding to the second media format; and
providing the formatted media data for sending to the client device.

18. The non-transitory computer-readable medium of claim 17, wherein generating the formatted media data comprises modifying the media data's container format to comply with the second media format, without decoding or encoding the media data.

19. The non-transitory computer-readable medium of claim 17, wherein generating the formatted media data comprises decoding the media data, processing the decoded media data, and re-encoding the processed media data with new parameters.

20. The non-transitory computer-readable medium of claim 17, wherein the formatted media data comprises one or more media data segments, wherein sending the formatted media data comprises sending the media data segments, and further comprising instructions executable by the one or more processors to cause the electronic device to perform:
sending to the client device index data describing locations and durations of the media data segments; and
receiving, from the client device, one or more additional requests for the media data segments.

21. The non-transitory computer-readable medium of claim 20, wherein the first media format is MP4, the second media format is supported by HTTP Live Streaming (HLS), wherein the index data has an M3U format, and further comprising instructions executable by the one or more processors to cause the electronic device to perform:
storing each of the media data segments in a separate file having an MPEG-2 Transport Stream (TS) format.

22. The non-transitory computer-readable medium of claim 17, further comprising instructions executable by the one or more processors to cause the electronic device to perform:
determining whether a fresh version of the media data is stored on the content cache and, based on the determination, obtaining the fresh version of the media data from the content cache.

23. The non-transitory computer-readable medium of claim 17, wherein sending to the client device a content type identifier is further based on a determination whether the first media format is one of predetermined media formats.

24. The non-transitory computer-readable medium of claim 17, further comprising instructions executable by the one or more processors to cause the electronic device to perform:
determining an operating system type of the client device.
